(19) United States
(12) Patent Application Publication
(10) Pub. No.: US 2013/0279818 A1
(43) Pub. Date: Oct. 24, 2013

(54) IMAGE ENCODING APPARATUS AND METHOD, IMAGE DECODING APPARATUS AND METHOD, AND NON-TRANSITORY COMPUTER READABLE MEDIUM

(71) Applicant: FUJI XEROX CO., LTD., Tokyo (JP)

(72) Inventor: Taro YOKOSE, Kanagawa (JP)

(73) Assignee: FUJI XEROX CO., LTD., Tokyo (JP)

(21) Appl. No.: 13/683,517

(22) Filed: Nov. 21, 2012

(30) Foreign Application Priority Data
Apr. 19, 2012 (JP) 2012-095419

(51) Int. Cl. G06T 9/00

(52) U.S. Cl. CPC G06T 9/004
USPC 382/233; 382/238

(57) ABSTRACT

An image encoding apparatus includes an input unit, a prediction unit, a prediction error calculating unit, and an encoder. The input unit receives, as an input, image data. The prediction unit calculates a predicted pixel value of a pixel of interest serving as a target to be processed in the image data. The prediction error calculating unit calculates a prediction error value by using an actual pixel value and the predicted pixel value of the pixel of interest. The encoder encodes the prediction error value with information including a number of bits and an error value. The encoder encodes, as the error value, only one or more most significant bits corresponding to a number of effective bits when the number of bits exceeds the number of effective bits.

### CROSS-REFERENCE TO RELATED APPLICATIONS

This application is based on and claims priority under 35 USC 119 from Japanese Patent Application No. 2012-095419 filed Apr. 19, 2012.

### BACKGROUND

(i) Technical Field

The present invention relates to an image encoding apparatus and method, an image decoding apparatus and method, and a non-transitory computer readable medium.

(ii) Related Art

Hitherto, various systems for encoding or compressing images have been proposed. Such systems include Joint Photographic Experts Group (JPEG) and Block Truncation Coding (BTC). The former is a variable-length encoding system, which reduces the encoding amount while keeping image quality deterioration at a low level by combining frequency conversion and quantization. The latter is a fixed-length encoding system, which is capable of encoding an image to a certain fixed encoding amount by representing a block with information of a fixed length.

In the JPEG system, the upper limit of the encoding amount is not controlled, and the size of an apparatus tends to increase when multiple lines (such as eight lines) of an image are processed at the same time. Also, the BTC system produces a fixed encoding amount even in response to an input with a small information amount.

### SUMMARY

According to an aspect of the invention, there is provided an image encoding apparatus including an input unit, a prediction unit, a prediction error calculating unit, and an encoder. The input unit receives, as an input, image data. The prediction unit calculates a predicted pixel value of a pixel of interest serving as a target to be processed in the image data. The prediction error calculating unit calculates a prediction error value by using an actual pixel value and the predicted pixel value of the pixel of interest. The encoder encodes the prediction error value with information including a number of bits and an error value. The encoder encodes, as the error value, only one or more most significant bits corresponding to a number of effective bits when the number of bits exceeds the number of effective bits.

### BRIEF DESCRIPTION OF THE DRAWINGS

Exemplary embodiments of the present invention will be described in detail based on the following figures, wherein:

FIG. 1 is a functional block diagram of an image encoding apparatus according to a first exemplary embodiment;

FIG. 2 is a diagram illustrating a specific example of the configuration illustrated in FIG. 1;

FIG. 3 is a diagram describing the number of bits and bit packing;

FIG. 4 is a diagram illustrating an example of encoded image data;

FIG. 5 is a flowchart of a process of the first exemplary embodiment;

FIG. 6 is a flowchart of another process of the first exemplary embodiment;

FIG. 7 is a diagram illustrating a specific example of the process illustrated in FIG. 6;

FIG. 8 is a flowchart of yet another process of the first exemplary embodiment;

FIG. 9 is a diagram illustrating a specific example of the process illustrated in FIG. 8;

FIG. 10 is a functional block diagram of an image decoding apparatus according to the first exemplary embodiment;

FIG. 11 is a diagram illustrating an example of encoded image data of a second exemplary embodiment;

FIG. 12 is a diagram illustrating an example of encoded image data of a third exemplary embodiment;

FIG. 13 is a functional block diagram of an image encoding apparatus according to a forth exemplary embodiment;

FIG. 14 is a diagram illustrating a specific example of the configuration illustrated in FIG. 13;

FIG. 15A is a functional block diagram of an encoding amount control apparatus of the related art;

FIG. 15B is a functional block diagram of an encoding amount control function of the image encoding apparatus of the fourth exemplary embodiment; and

FIG. 16 is a diagram illustrating settings of the number of additional bits.

### DETAILED DESCRIPTION

Hereinafter, exemplary embodiments of the present invention will be described on the basis of the drawings.

### First Exemplary Embodiment

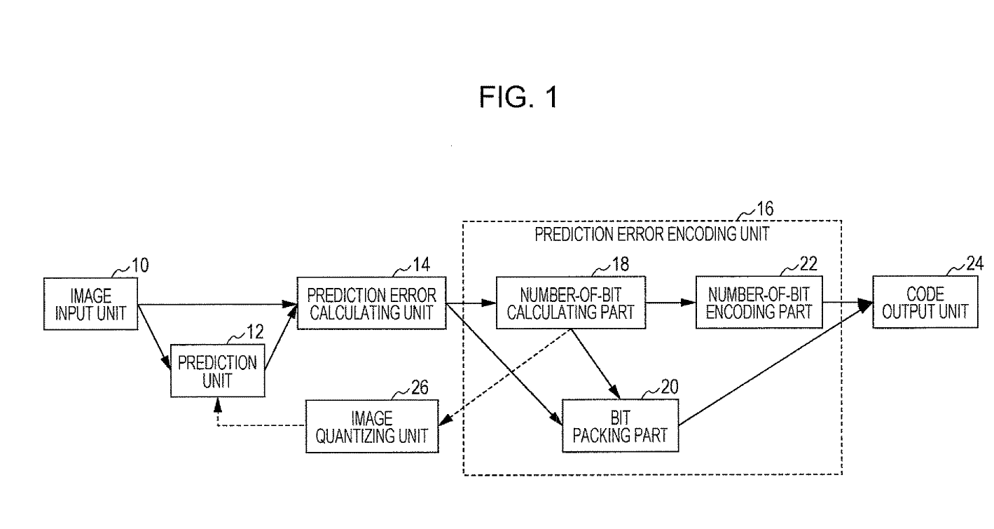

FIG. 1 is a functional block diagram of an image encoding apparatus according to a first exemplary embodiment. The image encoding apparatus includes an image input unit 10, a prediction unit 12, a prediction error calculating unit 14, a prediction error encoding unit 16, a code output unit 24, and an image quantizing unit 26.

The image input unit 10 obtains image data to be processed. An example of the image input unit 10 includes a scanner that scans a document and converts the document into electronic data. The image input unit 10 outputs the obtained image data to the prediction unit 12 and to the prediction error calculating unit 14.

The prediction unit 12 predicts the pixel value of a pixel of interest, that is, a pixel to be processed. For example, when performing line-by-line processing, the prediction unit 12 uses the pixel values of a line previous to a line of interest as predicted values. More particularly, the horizontal line serves as a fast scanning direction, and the vertical direction or a direction orthogonal to the fast scanning direction serves as a sub scanning direction. When processing is performed from top to bottom, the pixel values of a line one above a line of interest serves as predicted values. Needless to say, this is only an example. Another method such as that uses the pixel value of a pixel to the left of a pixel of interest as a predicted value when pixel-by-pixel processing is performed is possible. This case will be further described later.

The prediction error calculating unit 14 calculates the difference between the predicted value predicted by the prediction unit 12 and the actual pixel value of the pixel of interest. For example, when the predicted value of the pixel of interest is 16 and the actual pixel value of the pixel of interest is 20, a prediction error is calculated as 20−16=4. The prediction error calculating unit 14 outputs the calculated prediction error to the prediction error encoding unit 16.

The prediction error encoding unit 16 encodes the prediction error calculated by the prediction error calculating unit 14. The prediction error encoding unit 16 includes a number-of-bit calculating part 18, a bit packing part 20, and a number-of-bit encoding part 22.

The number-of-bit calculating part 18 calculates the number of bits that are capable of representing the prediction error value calculated by the prediction error calculating unit 14. For example, when the prediction error value is 4, since 4 is 0100 in binary, the number-of-bit calculating part 18 calculates the number of bits as 4. When the prediction error value is 26, since 26 is 011010 in binary, the number-of-bit calculating part 18 calculates the number of bits as 6. When calculating the number of bits of the prediction error value, the number-of-bit calculating part 18 calculates the number of bits by including the sign bit because the prediction error value may be a negative value. Among the numbers of bits of prediction errors of pixels to be processed, the number-of-bit calculating part 18 outputs the maximum number of bits to the number-of-bit encoding part 22 and the bit packing part 20. For example, when the numbers of bits that are capable of representing the prediction error values of pixels are 4 bits, 5 bits, and 6 bits, the number-of-bit calculating part 18 selects 6 bits, which is the maximum number of bits, as the number of bits.

The number-of-bit encoding part 22 encodes the number of bits calculated by the number-of-bit calculating part 18.

The bit packing part 20 calculates the number of effective bits on the basis of the number of bits calculated by the number-of-bit calculating part 18, and, with this number of effective bits, packs the prediction error values of the pixels in units of blocks. When packing a prediction error value, if the number of bits of the prediction error value exceeds the number of effective bits, the bit packing part 20 adopts only one or more most significant bits corresponding to the number of effective bits as the prediction error value. For example, given the number of effective bits as 4 bits, when the prediction error value is 26, since 26 is “011010” in binary, which is 6 bits exceeding 4 bits, the bit packing part 20 adopts only the four most significant bits “0110” of the 6 bits of the prediction error. Alternatively in this case, the least significant bit of the four most significant bits may be set by rounding the two least significant bits “10” of the original 6 bits. In this case, as a result of this rounding, the four most significant bits become “0111”. Rounding is a process of minimizing an error involved in adopting only the four most significant bits and is not necessarily performed.

Adopting only one or more most significant bits corresponding to the number of effective bits in the case where the number of bits of the prediction error value exceeds the number of effective bits is based on the fact that useful information is included in the most significant bits of the prediction error value.

The code output unit 24 outputs the encoded number of bits from the number-of-bit encoding part 22 and the packed prediction error values from the bit packing part 20 as encoded image data.

In contrast, the image quantizing unit 26 calculates a quantization error that has occurred in the bit packing part 20. The calculated quantization error is sent as a feedback to the prediction unit 12. In other words, the image quantizing unit 26 has the function of calculating a quantization error and the function of sending the quantization error as a feedback to the prediction unit 12.

For example, when the prediction error value of the pixel of interest is “4”, the image quantizing unit 26 outputs this prediction error value as an encoding error to the prediction unit 12. The prediction unit 12 uses this encoding error “4” when calculating the predicted value of the next pixel of interest. Specifically, the predicted value of the next pixel of interest is the pixel value of a pixel previous to this next pixel of interest. The predicted value of the next pixel of interest is modified by adding the encoding error to this pixel value of the previous pixel of the next pixel of interest. When the prediction error of the pixel of interest is “26”, “26” is packed by the bit packing part 20 and the prediction error value becomes “0111”=28. This encoding error “28” is output to the prediction unit 12. The prediction unit 12 uses this encoding error “28” when calculating the predicted value of the next pixel of interest.

The prediction unit 12, the prediction error calculating unit 14, the prediction error encoding unit 16, the code output unit 24, and the image quantizing unit 26 illustrated in FIG. 1 are specifically configured with a processor such as a central processing unit (CPU) and memories included in a computer. The processor reads a program stored in a program memory, such as a read-only memory (ROM), and executes the program, thereby realizing the functions of each of the units. An image encoding apparatus illustrated in FIG. 1 is connected to each terminal via a network and may be incorporated in a multi-functional machine with a scanner function, a print function, and the like.

Next, an encoding process of the first exemplary embodiment will be specifically described.

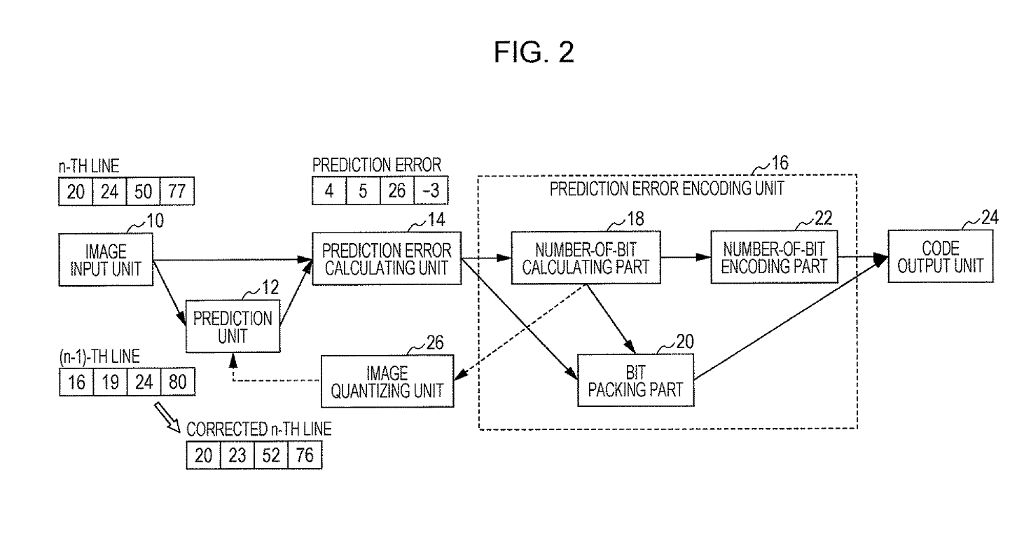

FIG. 2 illustrates a specific example of an encoding process performed by the configuration illustrated in FIG. 1. It is assumed that the image input unit 10 obtains an image, and, as a result, the pixel values of pixels constituting the (n−1)-th line of the image are, for example, “16”, “19”, “24”, “80”, . . . , and the pixel values of pixels constituting the n-th line are, for example, “20”, “24”, “50”, “77”, . . . . Encoding is performed in units of blocks. A processing block is constituted of 32 pixels×1 line. The prediction unit 12 predicts the pixel values of pixels of the n-th line, which is a line of interest, from the pixels of the (n−1)-th line, which is one above the n-th line or the line of interest. For example, the prediction unit 12 predicts the pixel values of the n-th line as the pixel values of the (n−1)-th line as they are, and predicts the pixel values of the n-th line as “16”, “19”, “24”, “80”, . . . . The actual pixel values of the n-th line, which are from the image input unit 10, and the predicted values of the n-th line, which are from the prediction unit 12, are both supplied to the prediction error calculating unit 14.

The prediction error calculating unit 14 calculates prediction error values by calculating the differences between the actual pixel values and the predicted values of the n-th line. Here,

the actual pixel values=20, 24, 50, 77; and

the predicted values=16, 19, 24, 80

Thus, the prediction error values are 20−16=4, 24−19=5, 50−24=26, and 77−80=−3. The calculated prediction error values “4”, “5”, “26”, and “−3” are supplied to the prediction error encoding unit 16.

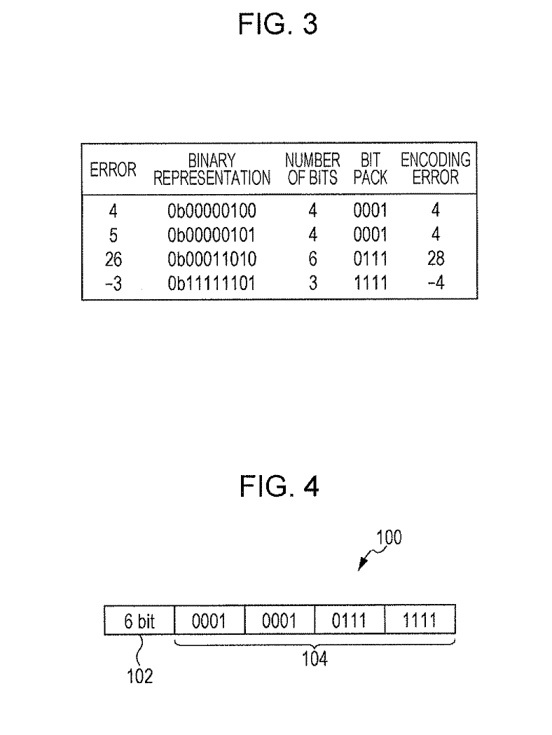

FIG. 3 illustrates an example of encoding performed by the prediction error encoding unit 16. The prediction error value “4” is represented with 8 bits as “0b00000100” in binary, and the number of bits that are capable of representing “0b00000100” including the sign bit is 4 bits. The prediction error value “5” is represented with 8 bits as “0b00000101” in binary, and the number of bits that are capable of representing “0b00000101” including the sign bit is 4 bits. The prediction error value “26” is represented with 8 bits as “0b00011010” in binary, and the number of bits that are capable of representing “0b00011010” including the sign bit is 6 bits. The prediction error value “−3” is represented with 8 bits as “0b11111101” in binary, and the number of bits that are capable of representing “0b11111101” including the sign bit is 3 bits. Among these numbers of bits, the number-of-bit calculating part 18 selects the maximum number of bits, namely, 6 bits.

The bit packing part 20 limits the number of effective bits to, for example, “4”, which is set in advance, and packs the prediction error values with this number of effective bits. At this time, the numbers of bits of the prediction error values to be packed are “4”, “4”, “6”, and “3”. Since “6”, which exceeds the number of effective bits “4”, is included, only the four most significant bits, corresponding to the number of effective bits, are adopted in order to reduce the number of bits to “4”, which is the number of effective bits. That is, the prediction error value “4” is “0b00000100” in binary. Among the six bits “000100”, the two least significant bits are truncated, and the four most significant bits are extracted to obtain “0001”. Alternatively, instead of truncating the two least significant bits, the two least significant bits may be rounded. Also, the prediction error value “5” is “0b00000101” in binary. Among the six bits “000101”, the two least significant bits “01” are truncated, and only the four most significant bits are extracted to obtain “0001”. Also, the prediction error value “26” is “0b00011010” in binary. Among the six bits “011010”, the two least significant bits “10” are truncated, and only the four most significant bits are extracted to obtain “0110”. Alternatively, instead of truncating the two least significant bits, attention is paid to the second least significant bit “1” of the two least significant bits “10”, and the second least significant bit “1” is rounded, thereby obtaining “0111”. FIG. 3 illustrates an example of this case. Also, the prediction error value “−3” is “0b11111101” in binary. Among the six bits “111101”, the two least significant bits “01” are truncated, and only the four most significant bits are extracted to obtain “1111”.

As above, the prediction error values “4”, “5”, “26”, and “−3” are encoded to “0001”, “0001”, “0111”, and “1111”, respectively, with 4 bits, which is the number of effective bits.

In contrast, encoding errors involved in the encoding above are as follows. That is, “0001” is the result of truncating the two least significant bits; the two least significant bits are added to “0001” to obtain 8-bit “00000100”. Thus, the encoding error is “00000100”=“4”. Also, the two least significant bits are added to “0111” to obtain 8-bit “00011100”=“28”. Also, the two least significant bits are added to “1111” to obtain 8-bit “11111100”=“−4”. In FIG. 3, the encoding errors of the prediction error values “4”, “5”, “26”, and “−3” are indicated as “4”, “4”, “28”, and “−4”, respectively. The image quantizing unit 26 calculates these encoding error values and sends the encoding error values as a feedback to the prediction unit 12.

Referring back to FIG. 2, when the image quantizing unit 26 calculates the encoding errors and sends the encoding errors as a feedback to the prediction unit 12, the prediction unit 12 uses the encoding errors to modify the pixel values of the n-th line, which serve as a reference, when calculating the predicted values of the (n+1)-th line, which is the next line. That is, the prediction unit 12 assumes the predicted values of the n-th line as “16”, “19”, “24”, and “80”, which are the pixel values of the (n−1)-th line. The prediction unit 12 adds the encoding error values “4”, “4”, “28”, and “−4” to “16”, “19”, “24”, and “80”, thereby modifying the pixel values of the n-th line. The pixel values of the modified n-th line become 16+4=20, 19+4=23, 24+28=52, and 80−4=76. In FIG. 2, these modified pixel values are indicated as the pixel values of the modified n-th line. The prediction unit 12 calculates these pixel values of the modified n-th line as the predicted values of the (n+1)-th line, which is the next line of interest, and outputs these pixel values to the prediction error calculating unit 14. That is, the prediction unit 12 encodes the n-th line, and then calculates the predicted values of the (n+1)-th line, which is the next line of interest, by using the encoding errors of the n-th line. By modifying the predicted values using the encoding errors, accumulation of the encoding errors is effectively suppressed.

FIG. 4 illustrates an example of encoded data (encoded image data) 100 output from the code output unit 24. The encoded prediction error values “0001”, “0001”, “0111”, and “1111” are packed in units of blocks to constitute an error part 104, and a header 102 defining 6 bits, which is the maximum number of bits of the prediction errors of a corresponding block, is added at the beginning. That is, the encoded data 100 includes the encoded prediction error values and is constituted of the number of bits and error values. Error values are limited to 4 bits, which is the number of effective bits, and errors with the number of bits greater than 4 bits do not exist. Therefore, the upper limit of the encoding amount is guaranteed for sure. In the JPEG system of the related art, the upper limit of the encoding amount is not controlled, which is distinctively different from the image encoding apparatus of the first exemplary embodiment. Also, the number of effective bits is set in accordance with, for example, the dynamic range of prediction error values. Accordingly, the number of effective bits is appropriately set to a small value for an input with a small amount of information, thereby controlling the average encoding amount.

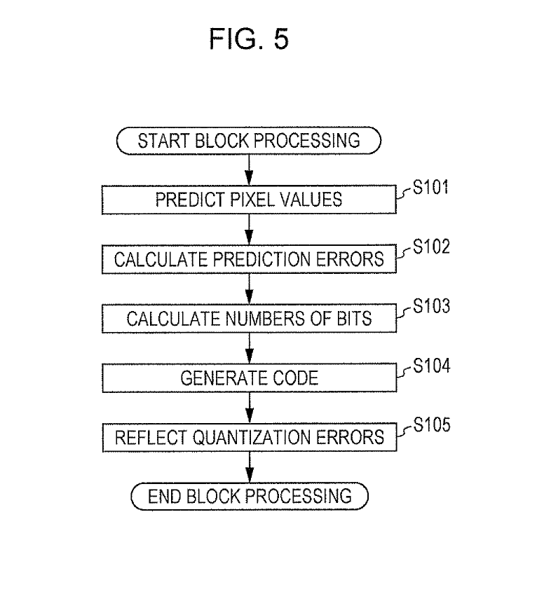

FIG. 5 is a flowchart of an encoding process of the first exemplary embodiment. At first, the prediction unit 12 predicts pixel values (9101). A prediction method is arbitrary. For example, the pixel values of the (n−1)-th line, which is one above the n-th line serving as the line of interest, are used as the predicted values of the n-th line.

Next, the prediction error calculating unit 14 calculates prediction errors (S102). Specifically, the prediction error calculating unit 14 calculates prediction error values by calculating the differences between the actual pixel values and the predicted pixel values of the line of interest.

Next, the number-of-bit calculating part 18 calculates the numbers of bits (the numbers of necessary bits (S103). That is, the number-of-bit calculating part 18 calculates the minimum numbers of bits required to represent the prediction error values. As above, when the prediction error values are “4”, “5”, “26”, and “−3”, the numbers of bits that are capable of representing “4”, “5”, “26”, and “−3”, including the sign bit, are 4 bits, 4 bits, 6 bits, and 3 bits, respectively. Among these bits, 6 bits, which is the maximum number of bits, is selected. Alternatively, a preset fixed value may be used as the number of effective bits. Alternatively, the number of effective bits may be set appropriately in accordance with the dynamic range of the prediction error values. In this example, it is assumed that the number of effective bits is set to “4” in advance.

Next, the bit packing part 20 and the number-of-bit encoding part 22 encode the prediction error values and the number of bits, respectively (S104). That is, the prediction error values of the line of interest are encoded and packed with 4 bits, which is the number of effective bits, and 6 bits, which is the maximum number of bits, are encoded and added as a header at the beginning.

Next, the image quantizing unit 26 calculates quantization errors, that is, encoding errors, and sends the quantization errors or encoding errors as a feedback to the prediction unit 12. The prediction unit 12 reflects the encoding errors in the predicted values of the (n+1)-th line, which is the next line of interest (S105). In the first exemplary embodiment, encoding with 4 bits, which is the number of effective bits, involves the occurrence of an error corresponding to the ignored two least significant bits. However, accumulation of errors is suppressed by reflecting the encoding errors in the predicted values of the next line, as described above.

Note that, in the first exemplary embodiment, a group of pixels constituting a line is treated as a block, and the encoding process is executed in units of blocks. Alternatively, the encoding process may be executed in units of pixels, instead of blocks.

Also, in the first exemplary embodiment, the prediction unit 12 predicts the pixel values of the next line of interest without using already processed pixels. Alternatively, the pixel values of the next line of interest may be predicted by using already processed pixels. Next, a process in this case will be described.

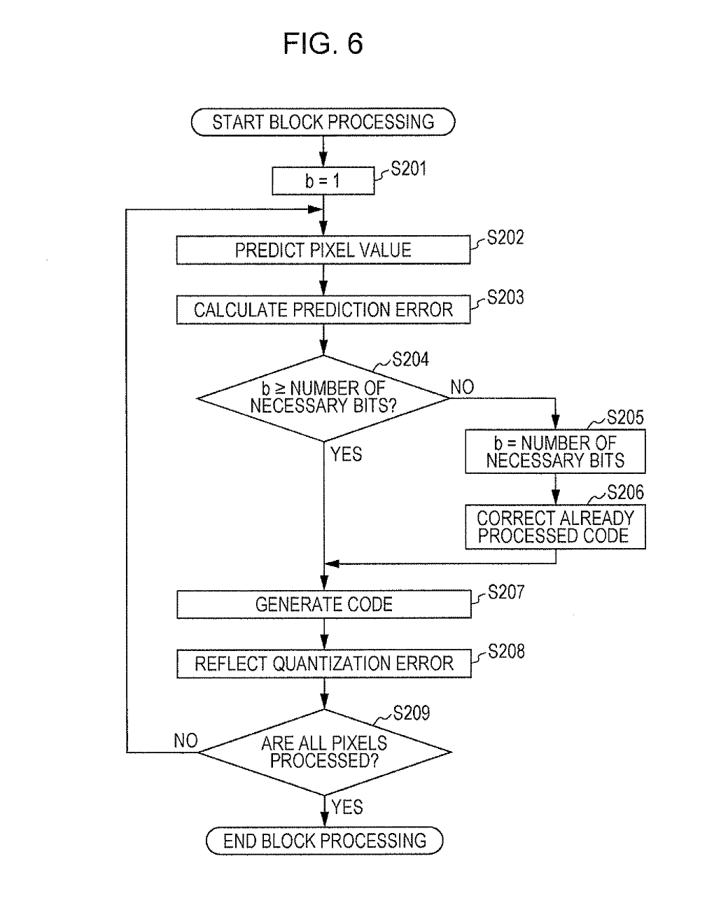

FIG. 6 is a flowchart of a process when prediction is performed by using an already processed pixel and encoding is performed. Specifically, this process is a process of repeatedly encoding the pixel value of a pixel of interest by using the pixel value of the left adjacent pixel.

At first, an argument b indicating the number of necessary bits is initialized to 1 (S201), and the pixel value of a pixel of interest is predicted (S202). Specifically, the pixel value of a pixel to the left of the pixel of interest serves as the predicted value of the pixel of interest. The difference between the actual pixel value and the predicted value of the pixel of interest is calculated to obtain the prediction error value of the pixel of interest (S203).

Next, the number of bits necessary to represent the prediction error value is calculated, and whether this number of necessary bits is less than or equal to the argument b is determined (S204). The initial value of the argument b is set to 1 (b=1) in S201, as above. Generally, prediction error values may not be represented with one bit. Thus, it is determined NO in S204, and the number of necessary bits is set to the argument b (S205). For example, the prediction error value is 31, and 6 bits are necessary for representing 31. Thus, the argument b is set to 6 (b=6). Needless to say, the argument b may be maintained as 1 (b=1) depending on the prediction error value. In this case, the argument b remains as it is.

After the argument b is set, an already processed code is modified (S206). Modification of the already processed code will be described later. The prediction error value is encoded with the number of effective bits (S207), and the quantization error (encoding error) is calculated. The quantization error is sent as a feedback to the prediction unit 12, thereby reflecting the quantization error in the next predicted value (S208).

The process in S202 to S208 is executed for all the pixels. After the process for all the pixels is executed, the process ends (S209).

As long as the number of necessary bits that are capable of representing the calculated prediction error value is less than or equal to the argument b, the value of the argument b is maintained as it is. The predicted pixel value of each pixel is sequentially encoded with the number of effective bits, and the quantization error (encoding error) is reflected (when. YES in S204).

In contrast, when the prediction error value is great and the number of bits necessary for representing the prediction error value exceeds the argument b, because the number of necessary bits, as it is, is insufficient for representing the prediction error value, the number of necessary bits is set again, and encoding is performed again with the newly set number of necessary bits. For example, even when the number of necessary bits is 6 bits (b=6), if the prediction error value exceeds “31”, which is the upper limit that 6 bits are capable of representing, the necessary bits are set from 6 bits to 7 bits since the prediction error value may not be represented. The above process is repeatedly executed, thereby sequentially encoding all the pixels.

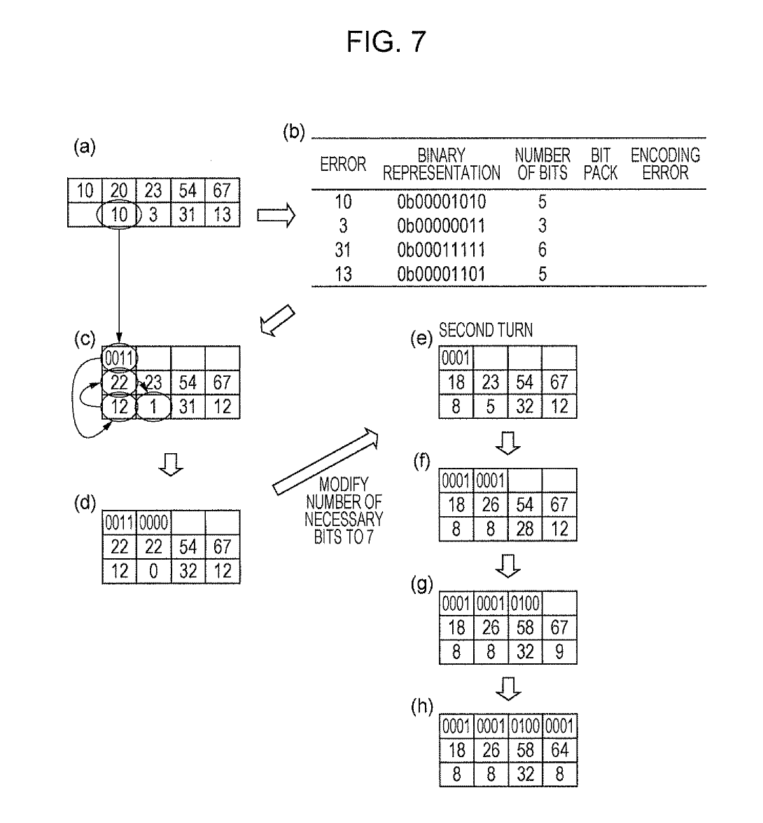

FIG. 7 illustrates a specific example of the process illustrated in FIG. 6. The specific example is the case where prediction starts from a pixel to the left of the pixel of interest. As illustrated in portion (a) of FIG. 7, it is assumed that the pixel values of the n-th line are “10”, “20”, “23”, “54”, and “67”. When the pixels constituting the n-th line are assumed as the first, second, third, fourth, and fifth from the left, the prediction unit 12 uses the pixel value “10” of the first pixel, which is the leftmost pixel, as the predicted value of the second pixel. The prediction error calculating unit 14 calculates the prediction error value of the second pixel as: 20−10=10. Similarly, the pixel value “20” of the second pixel is used as the predicted value of the third pixel, and the prediction error value of the third pixel is: 23−20=3. Also, the pixel value “23” of the third pixel is used as the predicted value of the fourth pixel, and the prediction error value of the fourth pixel is: 54−23=31. Also, the pixel value “54” of the fourth pixel is used as the predicted value of the fifth pixel, and the prediction error value of the fifth pixel is: 67−54=13.

The calculated prediction error values “10”, “3”, “31”, and “13” are in binary “0b00001010”, “0b00000011”, “0b00011111”, and “0b00001101”, respectively, as illustrated in portion (b) of FIG. 7, and the numbers of necessary bits for representing the prediction error values are 5 bits, 3 bits, 6 bits, and 5 bits, respectively. The number of necessary bits is provisionally set to 6 bits, and the number of effective bits is set to 4 bits. In order to encode the prediction error value “10” with 4 bits, which is the number of effective bits, the two least significant bits “10” of the 6-bit “001010” are rounded, and only the four most significant bits are extracted to obtain “0011”.

As illustrated in portion (c) of FIG. 7, “0011” encoded with 4 bits, which is the number of effective bits, is represented with 8 bits as “00001100”=12. This encoding error “12” is added to “10”, which is the pixel value of the first pixel, thereby modifying the pixel value of the second pixel to “22”. The pixel value “22” of the second pixel, which has been modified with the encoding error, serves as the predicted value of the third pixel. Thus, the prediction error value of the third pixel is modified as: 23−22=1.

As illustrated in portion (d) of FIG. 7, the prediction error value “1” is “0b0000001” in binary, which becomes “0000” in terms of 4 bits, which is the number of effective bits. This “0000” is represented with 8 bits as “00000000”=0. This encoding error “0” is added to “22”, which is the pixel value of the third pixel, thereby modifying the pixel value of the third pixel to “22”. Since the pixel value of the third pixel serves as the predicted value of the fourth pixel, the prediction error value of the fourth pixel is modified as: 54−22=32.

However, the prediction error value “32” is “0b00100000” in binary, and 7 bits are necessary for representing “0b00100000”. The number of necessary bits exceeds 6 bits, which is the original number of necessary bits (overflow). Thus, the maximum number of necessary bits is modified from 6 bits to 7 bits, and encoding is performed again.

That is, as illustrated in portion (e) of FIG. 7, “10”, which is the prediction error value of the second pixel, is “0b00001010” in binary, as described above. In order to reduce 7, which is the number of necessary bits, to 4, which is the number of effective bits, the three least significant bits are truncated (or rounded). The three least significant bits of “00001010” are rounded, and the four most significant bits are extracted, thereby obtaining “0001”. This is represented with 8 bits as “00010000”=8. Thus, the pixel value of the second pixel is modified as: 10+8=18. Since the pixel value of the second pixel serves as the predicted value of the third pixel, the prediction error value of the third pixel is modified as: 23−18=5.

As illustrated in portion (f) of FIG. 7, the prediction error value “5” is “0b00000101” in binary. In order to reduce the number of necessary bits to 4, which is the number of effective bits, the three least significant bits are rounded, and the four most significant bits are extracted, thereby obtaining “0001”. This is represented with 8 bits as “00010000”=8. Thus, the pixel value of the third pixel is modified as: 18+8=26. Since the pixel value of the third pixel serves as the predicted value of the fourth pixel, the prediction error value of the fourth pixel is modified as: 54−26=28. This prediction error value “28” falls within a range that 7 bits, which is the number of necessary bits, are capable of representing.

As illustrated in portion (g) of FIG. 7, the prediction error value “28” is “0b00011100” in binary. In order to reduce 7, which is the number of necessary bits, to 4, which is the number of effective bits, the three least significant bits are rounded, The three least significant bits of “00011100” are rounded, and the four most significant bits are extracted, thereby obtaining “0100”. This is represented with 8 bits as “00100000”=32. Thus, the pixel value of the fourth pixel is modified as: 26+32=58. Since the pixel value of the fourth pixel serves as the predicted value of the fifth pixel, the prediction error value of the fifth pixel is modified as: 67=58=9.

As illustrated in portion (h) of FIG. 7, the prediction error value “9” is “0b00000101” in binary. In order to reduce the number of necessary bits to 4, which is the number of effective bits, the three least significant bits are rounded, and the four most significant bits are extracted, thereby obtaining “0001”. This is represented with 8 bits as “00001000”=8. Thus, the pixel value of the fifth pixel is modified as: 58+8=64.

As above, when a prediction error value exceeds the number of necessary bits, the number of necessary bits is changed so as to be capable of representing the prediction error value, and encoding is performed again. Consequently, all the prediction error values may be encoded.

In the example illustrated in FIGS. 6 and 7, when a prediction error value is great, the number of necessary bits for representing the prediction error value is appropriately set again, and encoding is repeated. Even when an already processed pixel is used in prediction, a processing method of fixing the number of necessary bits may be possible. Hereinafter, this case will be described.

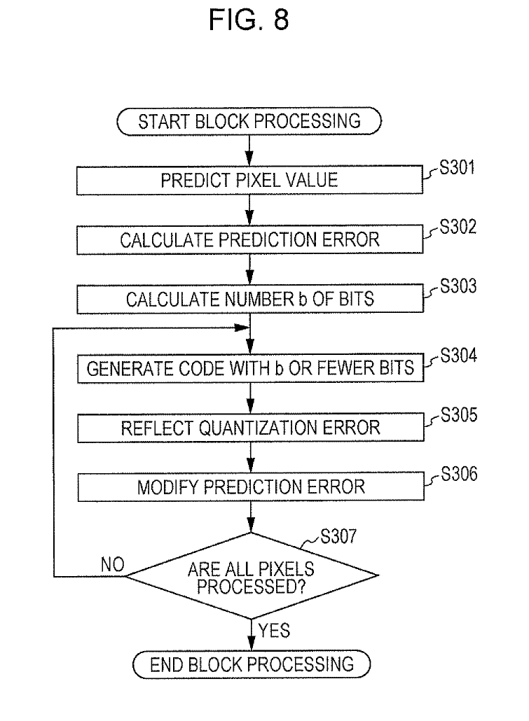

FIG. 8 is a flowchart of a process of fixing the number of necessary bits. At first, the pixel value of a pixel of interest is predicted (S301). Specifically, the pixel value of a pixel to the left of the pixel of interest serves as the predicted value of the pixel of interest. The difference between the actual pixel value and the predicted value of the pixel of interest is calculated to obtain a prediction error (S302).

Next, the number b of bits necessary to represent the prediction error value is calculated (S303). The calculated number b of necessary bits is fixed, without being changed, thereafter. For example, when the prediction error value is “31”, the number of necessary bits is set to 6 bits, and this value is maintained as it is thereafter. After the number b of necessary bits is calculated and set, prediction error values are encoded with this b or fewer bits (S304). Even when a prediction error value is great and may not be represented with the number b of necessary bits, the prediction error value is forcedly rounded to be representable with the number b of necessary bits. For example, when the prediction error value is “32”, 6 bits are incapable of representing “32”, as described above, and 7 bits are necessary. Thus, “32” is rounded to “31”, and “31” is represented with 6 bits.

After the prediction error value is rounded, as needed, and encoded, a quantization error (encoding error) is calculated and reflected (S305), and the prediction error value is modified (S306). The above process is repeatedly executed for all the pixels (S307).

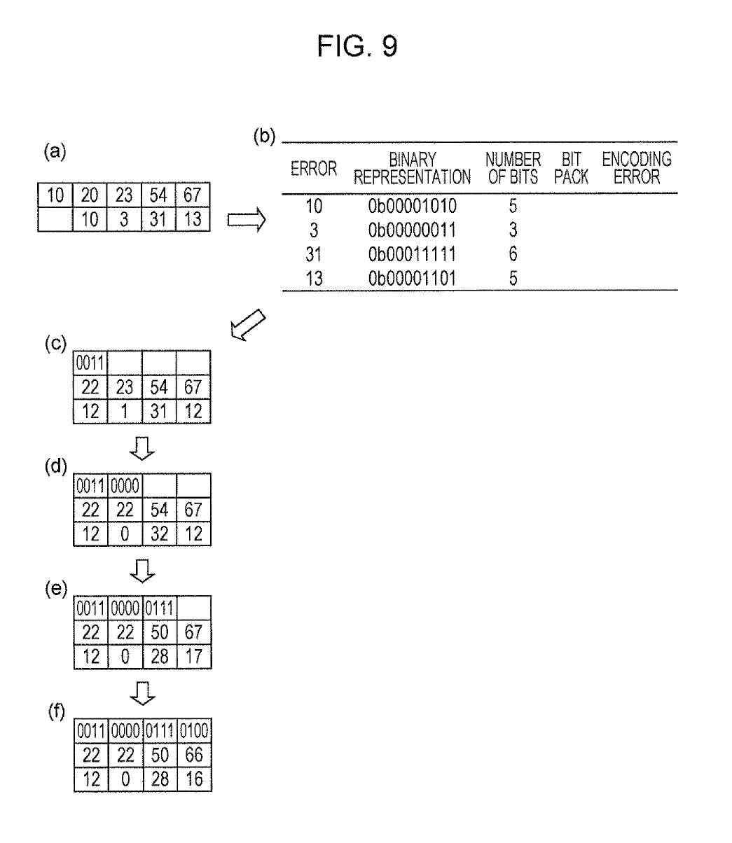

FIG. 9 illustrates a specific example of the process illustrated in FIG. 8. The specific example is the case where prediction starts from a pixel to the left of the pixel of interest. As illustrated in portion (a) of FIG. 9, it is assumed that the pixel values of the n-th line are “10”, “20”, “23”, “54”, and “67”. When the pixels constituting the n-th line are assumed as the first, second, third, fourth, and fifth from the left, the pixel value “10” of the first pixel, which is the leftmost pixel, is used as the predicted value of the second pixel. The prediction error value of the second pixel is: 20−10=10. Similarly, the pixel value “20” of the second pixel is used as the predicted value of the third pixel, and the prediction error value of the third pixel is: 23−20=3. Also, the pixel value “23” of the third pixel is used as the predicted value of the fourth pixel, and the prediction error value of the fourth pixel is: 54−23=31. Also, the pixel value “54” of the fourth pixel is used as the predicted value of the fifth pixel, and the prediction error value of the fifth pixel is: 67−54=13.

The prediction error values “10”, “3”, “31”, and “13” are in binary “0b00001010”, “0b00000011”, “0b00011111”, and “0b00001101”, respectively, as illustrated in portion (b) of FIG. 9, and the numbers of necessary bits for representing the prediction error values, including the sign bit, are 5 bits, 3 bits, 6 bits, and 5 bits, respectively. The number of necessary bits is set to 6 bits, and the number of effective bits is set to 4 bits. In order to encode the prediction error value “10” with 4 bits, which is the number of effective bits, the two least significant bits “10” of the 6-bit “001010” are rounded, and only the four most significant bits are extracted to obtain “0011”.

As illustrated in portion (c) of FIG. 9, the encoded “0011” is represented with 8 bits as “00001100”=12. This encoding error “12” is added to “10”, which is the predicted value of the second pixel, thereby modifying the pixel value of the second pixel to “22”. Since the pixel value “22” of the second pixel serves as the predicted value of the third pixel, the prediction error value of the third pixel is modified as: 23−22=1.

As illustrated in portion (d) of FIG. 9, the prediction error value “1” is “0b0000001” in binary, which becomes “0000” in terms of 4 bits, which is the number of effective bits. This “0000” is represented with 8 bits as “00000000”=0. This encoding error “0” is added to “22”, which is the predicted value of the third pixel, thereby modifying the pixel value of the third pixel to “22”. Since the pixel value of the third pixel serves as the predicted value of the fourth pixel, the prediction error value of the fourth pixel is modified as: 54−22=32.

Next, as illustrated in portion (e) of FIG. 9, the prediction error value “32” is unrepresentable with 6 bits, and 7 bits are necessary. However, in this process, all the prediction error values are represented with 6 or fewer bits. That is, the prediction error value “32” is rounded to “31”, which becomes “0111”. This “0111” is represented with 8 bits as “00011100”=28. This encoding error “28” is added to “22”, which is the predicted value of the pixel value of the fourth pixel, thereby modifying the pixel value of the fourth pixel to “50”. Since the pixel value of the fourth pixel serves as the predicted value of the fifth pixel, the prediction error value of the fifth pixel is modified as: 67−50=17.

Finally, as illustrated in portion (f) of FIG. 9, the prediction error value “17” is “0b00010000” in binary, which becomes “0100” in terms of 4 bits, which is the number of effective bits. This “0100” is represented with 8 bits as “00010000”=16. This encoding error “16” is added to “50”, which is the predicted value of the fifth pixel, thereby modifying the pixel value of the fifth pixel to “66”.

As above, repeated encoding is avoided by fixing the number of necessary bits, thereby reducing the processing time. An error that occurs as a result of rounding a prediction error value to the number of necessary bits or less is sent, as a feedback, as a quantization error (encoding error) and the predicted value is modified. Therefore, accumulated errors are also suppressed.

Next, an image decoding apparatus corresponding to the image encoding apparatus illustrated in FIG. 1 will be described.

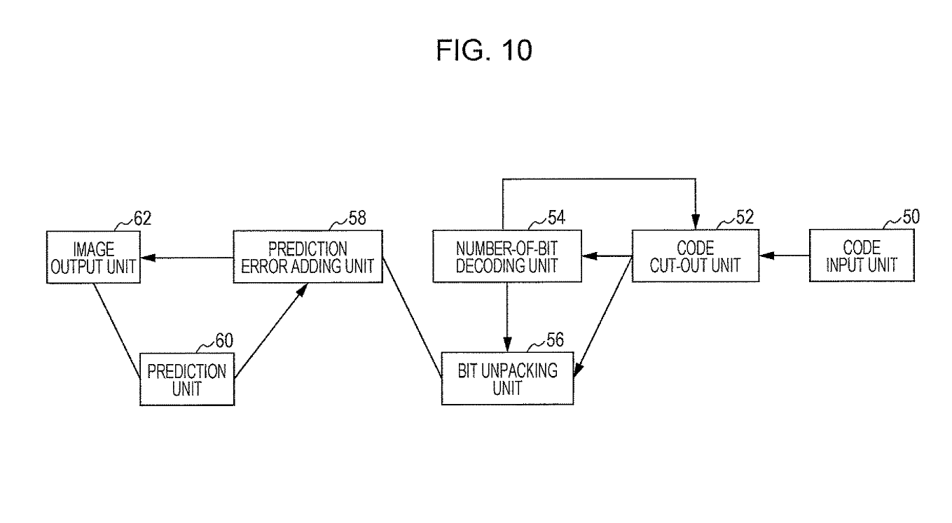

FIG. 10 is a functional block diagram of the image decoding apparatus. The image decoding apparatus includes a code input unit 50, a code cut-out unit 52, a number-of-bit decoding unit 54, a bit unpacking unit 56, a prediction error adding unit 58, a prediction unit 60, and an image output unit 62.

The code input unit 50 is a functional block corresponding to the code output unit 24 illustrated in FIG. 1. The code input unit 50 obtains image data encoded by the image encoding apparatus illustrated in FIG. 1. An example of the encoded image data is, for example, as illustrated in FIG. 4.

The code cut-out unit 52 cuts out the next code from the encoded image data in accordance with the number of bits and bit packing involved therein. Specifically, the number of effective bits in the image encoding apparatus is known to the image decoding apparatus. Using this number of effective bits, the code cut-out unit 52 cuts out a code. For example, in encoded image data such as that illustrated in FIG. 4, when the number of effective bits is 4 bits, the code cut-out unit 52 cuts out “0001” as 4-bit encoded data, “0001” as the next 4-bit encoded data, “0111” as the next 4-bit encoded data, and “1111” as the next 4-bit encoded data. Also, the code cut-out unit 52 cuts out information of the number of bits, which is included in the header of the encoded image data. The code cut-out unit 52 outputs the number-of-bit information included in the header to the number-of-bit decoding unit 54, and outputs the sequentially cut-out pieces of 4-bit data, namely, the encoded prediction error values, to the bit unpacking unit 56.

The number-of-bit decoding unit 54 is a functional block corresponding to the number-of-bit encoding part 22 illustrated in FIG. 1. The number-of-bit decoding unit 54 performs the inverse process of the process performed by the number-of-bit encoding part 22, and decodes the number of bits. Accordingly, for example, the number of bits of the prediction error value is decoded to 6 bits.

The bit unpacking unit 56 is a functional block corresponding to the bit packing part 20 illustrated in FIG. 1. The bit unpacking unit 56 performs the inverse process of the process performed by the bit packing part 20, and calculates the prediction error value. That is, when the prediction error value is represented with 6 bits, since the number of effective bits is 4 bits, which is known, the two least significant bits are truncated (or rounded) at the time of encoding, and only the four most significant bits are extracted and encoded. Thus, the prediction error value is calculated by adding “00” to the two least significant bits of the 4-bit data.

The prediction error adding unit 58 is a functional block corresponding to the prediction error calculating unit 14 illustrated in FIG. 1. The prediction error adding unit 58 performs the inverse process of the process performed by the prediction error calculating unit 14, and calculates the decoded pixel value (expanded pixel value). Specifically, the decoded pixel value is calculated by adding the prediction error value to the predicted value of the pixel of interest, which has been predicted by the prediction unit 60. The prediction error adding unit 58 outputs the decoded (expanded) pixel value to the image output unit 62.

The prediction unit 60 is a functional block corresponding to the prediction unit 12 illustrated in FIG. 1. The prediction unit 60 calculates the predicted value of the pixel of interest on the basis of the decoded pixel value. Specifically, the decoded pixel value serves, as it is, as the predicted value of the next pixel of interest. The prediction error adding unit 58 decodes the pixel value of the pixel of interest by adding the prediction error value to the pixel value predicted by the prediction unit 60.

The Inventor has confirmed that, as a result of evaluating the signal-to-noise (SN) ratio in the case where a certain original image is encoded with the method of the first exemplary embodiment (the number of effective bits is 4 bits) and the SN ratio in a comparative example where encoding is performed simply by masking the four least significant bits of the pixel value, 29.67 dB is obtained in the first exemplary embodiment, whereas 29.20 dB is obtained in the comparative example. Also, the Inventor has confirmed that, as a result of evaluating the structural similarity (SSIM) index, which is one of image evaluation indices, for the same original image in the first exemplary embodiment and in the comparative example, 94.55% is obtained in the first exemplary embodiment, whereas 91.52% is obtained in the comparative example.

### Second Exemplary Embodiment

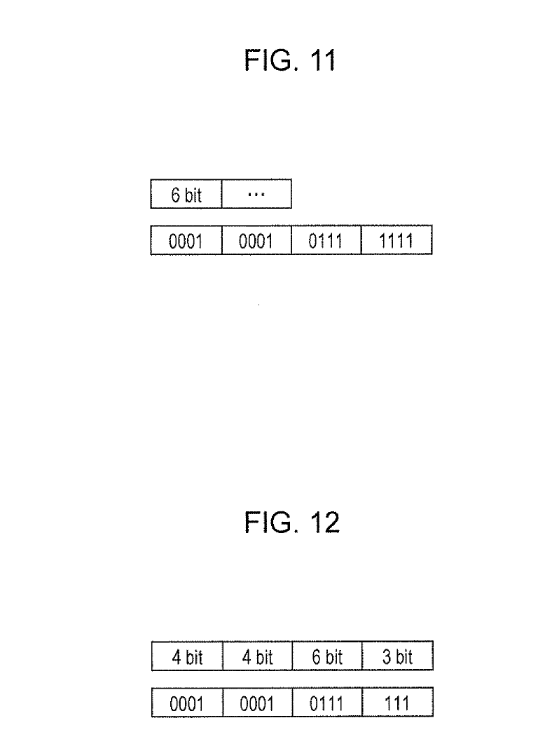

In the first exemplary embodiment described above, as illustrated in FIG. 4, the number-of-bit information is added as the header at the beginning of the bit-packed prediction error values. Alternatively, as illustrated in FIG. 11, the number-of-bit information may be stream data different from the bit-packed prediction error values. The number-of-bit information as different stream data may be encoded using, for example, run-length encoding or Huffman coding.

### Third Exemplary Embodiment

In the first exemplary embodiment described above, the number of bits is the same value in encoding in units of blocks (see FIGS. 5 and 8; although the number of bits changes in FIG. 6, the final number of bits is uniform). Alternatively, the number of bits may be changed on a pixel-by-pixel basis. In this case, the number-of-bit information is added to each pixel, as illustrated in FIG. 12. In FIG. 12, the numbers of bits “4”, “4”, “6”, and “3” in FIG. 3 are used as they are. The number-of-bit information may be different stream data, as in FIG. 11, which may be encoded using run-length encoding or Huffman coding.

### Fourth Exemplary Embodiment

In the first exemplary embodiment, the prediction error values are encoded with the number of effective bits. However, the first exemplary embodiment is not limited to this case and is applicable to variable-length encoding, such as JPEG. Next, an example of the case in which the first exemplary embodiment is applied to Huffman coding of JPEG will be described.

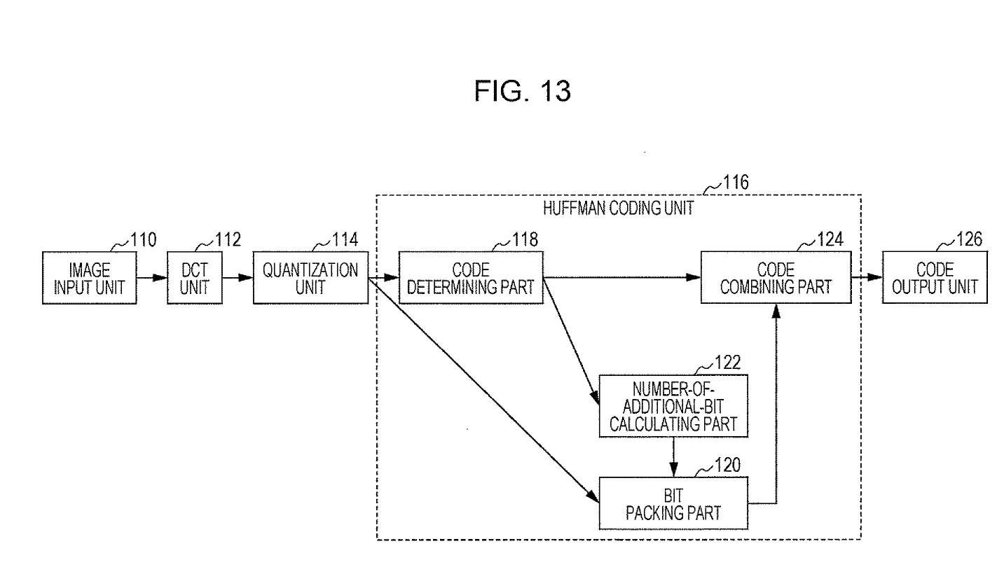

FIG. 13 is a functional block diagram of an image encoding apparatus according to the fourth exemplary embodiment. The image encoding apparatus of the fourth exemplary embodiment includes an image input unit 110, a discrete cosine transform (DCT) unit 112, a quantization unit 114, a Huffman coding unit 116, and a code output unit 126. The Huffman coding unit 116 further includes a code determining part 118, a number-of-additional-bit calculating part 122, a bit packing part 120, and a code combining part 124.

The image input unit 110 obtains image data. The DCT unit 112 executes a discrete cosine transform (DCT) on a block of the obtained image data and outputs the processed block to the quantization unit 114.

The quantization unit 114 quantizes coefficients of the DCT and outputs the quantized coefficients to the Huffman coding unit 116.

The code determining part 118 of the Huffman coding unit 116 determines codes to be assigned to the quantization result obtained by the quantization unit 114. The number-of-additional-bit calculating part 122 of the Huffman coding unit 116 determines the number of additional bits in accordance with the assigned codes. Here, the additional bits refer to bits of data indicating particular values of the codes assigned by the code determining part 118, namely, a group of symbols. The number of additional bits in the fourth exemplary embodiment corresponds to the number of effective bits in the first exemplary embodiment. The bit packing part 120 of the Huffman coding unit 116 packs the bits by using the additional bits determined by the number-of-additional-bit calculating part 122. The code combining part 124 of the Huffman coding unit 116 generates encoded image data by combining the codes determined by the code determining part 118 and the bits packed by the bit packing part 120, and outputs the encoded image data to the code output unit 126.

Next, an encoding process of the fourth exemplary embodiment will be specifically described.

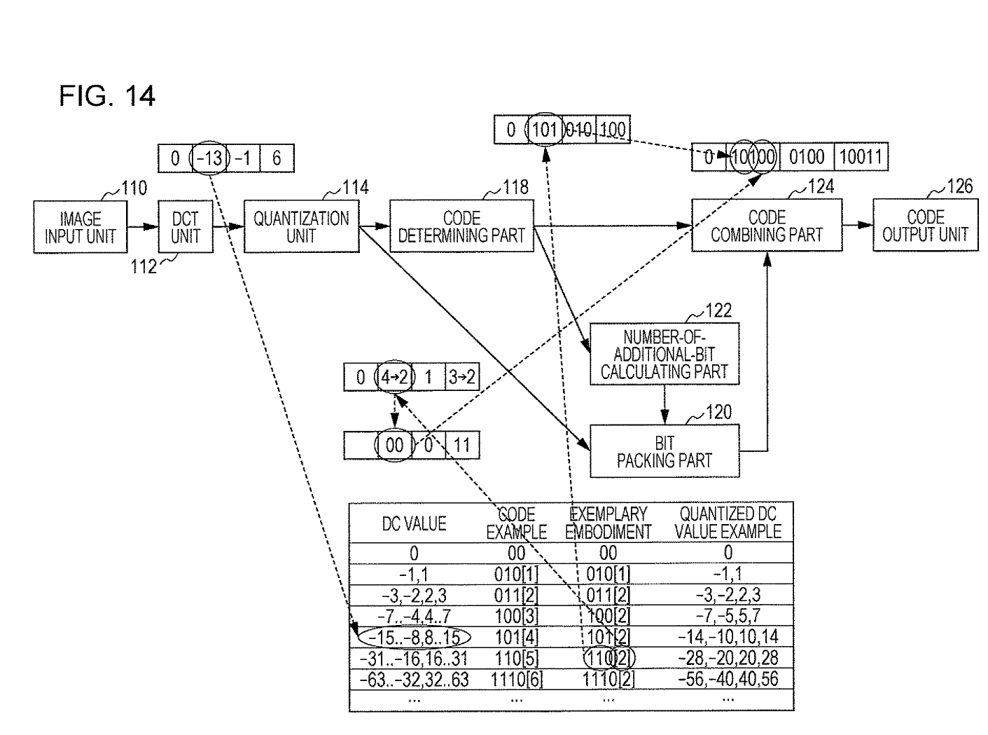

FIG. 14 illustrates a specific example of an encoding process performed by the configuration illustrated in FIG. 13. It is assumed that the DCT values obtained as a result of performing DCT by the DCT unit 112 on image data obtained by the image input unit 110 are, for example, “0”, “−13”, “−1”, and “6”. Note that actually only one DC value appears at the beginning of a block, and thereafter multiple AC values succeed. Thus, no multiple DC values will succeed in each block, as above. However, in order to simplify the description, AC values are ignored, and only DC values are illustrated. Needless to say, the process of the fourth exemplary embodiment is similarly applicable not only to DC values but also to AC values.

The code determining part 118 encodes these DC values. With reference to an encoding table additionally illustrated in FIG. 14, the DC value “0” is encoded to become “00”. Also, the number of additional bits is 0. Similarly, the DC value “−13” is encoded to become “101”. When the DC values are “−15, −14, −13, −12, −11, −10, −9, −8, 8, 9, 10, 11, 12, 13, 14, and 15” in FIG. 14, these are indicated to be encoded to “101”. Therefore, an arrow indicates that the DC value “−13” is also encoded to “101” in accordance with this table. In the encoding table, the default numbers of additional bits are parenthesized together with code examples. The default value of the number of additional bits of a group to which the DC value “−13” belongs is “4”. In contrast, in the fourth exemplary embodiment, the upper limit of the encoding amount is controlled by limiting the number of additional bits to a certain number of bits. For example, as indicated in the encoding table illustrated in FIG. 14, the number of additional bits is limited to “2”. Therefore, the number-of-additional-bit calculating part 122 changes the number of additional bits for the DC value “13” from “4”, which is default, to “2”. In accordance with the change of the number of additional bits from “4” to “2”, the bit packing part 120 represents the additional bits with 2 bits. Specifically, if it is assumed that the additional bits of the DC value “−13” are “0010”, the two least significant bits of “0010” are truncated, and the only two most significant bits are extracted to obtain “00”.

Also, the DC value “−1” is encoded to “010” in accordance with the encoding table. Since the default number of additional bits is “1”, the number-of-additional-bit calculating part 122 maintains this value as it is. Also, the bit packing part 120 maintains the additional bit as 1-bit “0”. Note that the additional bits are more specifically bits that indicate the order from the smallest one in that group. The group to which “−1” belongs includes −1 and 1, and −1 is the first from the smallest one. Thus, the additional bit is “0”. For example, in the group to which “−4” belongs, the additional bits of “−7” are “000”; the additional bits of “−6” are “001”; the additional bits of “−5” are “010”; the additional bits of “−4” are “011”; the additional bits of “4” are “100”; the additional bits of “5” are “101”; the additional bits of “6” are “110”; and so forth.

Also, the DC value “6” is encoded to “100” in accordance with the encoding table. Although the default number of additional bits is “3”, the number-of-additional-bit calculating part 122 limits the number of additional bits to “2”. In accordance with the change of the number of additional bits from “3” to “2”, the bit packing part 120 represents the additional bits with 2 bits. Specifically, since the additional bits of the DC value “6” are “110”, the least significant bit is truncated, and only the two most significant bits are extracted to obtain “11”.

As above, the code determining part 118 determines codes, and the bit packing part 120 packs the additional bits. Then, the code combining part 124 combines the codes and the additional bits. In the case of the DC value “0”, the encoding result is “0”, and the number of additional bits is “0”. Thus, the combining result obtained by the code combining part 124 remains as “0”.

In the case of the DC value “−13”, the encoding result is “101”, and the additional bits are “00”. “101” and “00” are combined to obtain “10100”. Since the default number of additional bits is 4, the default combining result becomes 7 bits. However, in the fourth exemplary embodiment, the combining result is limited to 5 bits.

In the case of the DC value “−1”, the encoding result is “010”, and the additional bit is “0”. “010” and “0” are combined to obtain “0100”.

In the case of the DC value “6”, the encoding result is “100”, and the additional bits are “11”. “100” and “11” are combined to obtain “10011”. Since the default number of additional bits is 3, the default combining result becomes 6 bits. However, in the fourth exemplary embodiment, the combining result is limited to 5 bits.

As is clear from the encoding table, the greater the absolute value of the DC value, the greater the default number of additional bits becomes, such as 4 bits, 5 bits, 6 bits, . . . . Therefore, the effect of suppressing the encoding amount by limiting the number of additional bits in the fourth exemplary embodiment becomes great. Also, the encoding table illustrated in FIG. 14 additionally indicates quantized DC value examples of each group when the number of additional bits is limited to 2 bits. For example, since the number of additional bits is limited from “3” to “2” in the group to which the DC value “−4” belongs, the number of DC values belonging to this group is limited from 8 to 4. Therefore, quantized DC values include four DC values, such as “−7”, “−5”, “5”, and “7”. Similarly, since the number of additional bits is limited from “4” to “2” in the group to which the DC value “−13” belongs, the number of DC values belonging to this group is limited to 4. Therefore, quantized DC values include four DC values, such as “−14”, “−10”, “10”, and “14”.

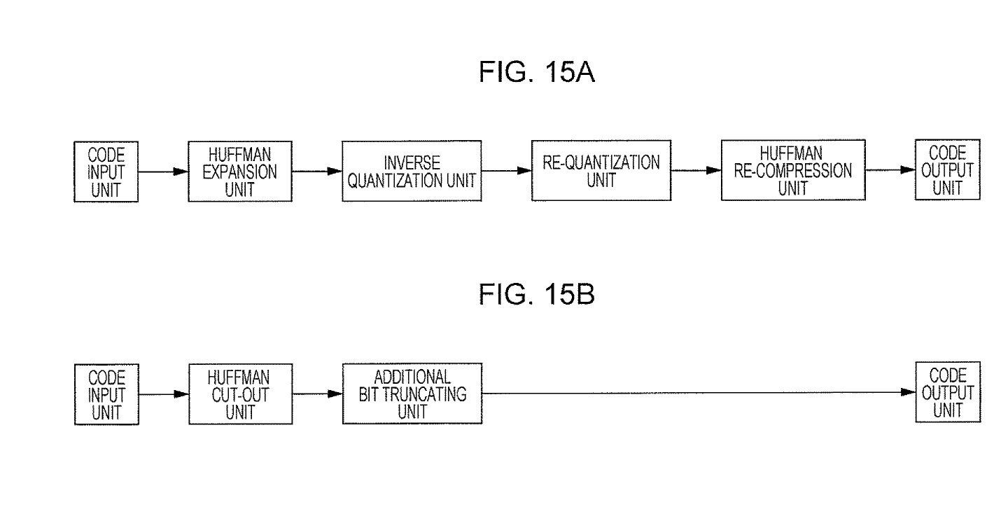

FIGS. 15A and 15B illustrate a comparison between the functional block diagram of a general encoding amount control apparatus of the related art and the block diagram of an encoding amount control function of the image encoding apparatus of the fourth exemplary embodiment. In general, the encoding amount is limited by inputting Huffman-coded data, expanding the Huffman-coded data, inverse-quantizing the expanded data, re-quantizing the inverse-quantized data, and Huffman-recompressing the quantized data. In contrast, in the fourth exemplary embodiment, as described above, the encoding amount is limited simply by cutting out Huffman codes and truncating the one or more least significant bits of additional bits. That is, when the number of additional bits is limited to a certain number, such as 2 bits, if the number of additional bits exceeds 2 bits, the one or more least significant bits are truncated, and only the two most significant bits are simply extracted. Therefore, the configuration in the fourth exemplary embodiment is simplified, compared with the configuration of the general encoding amount limiting apparatus of the related art. Unlike the related art, the fourth exemplary embodiment does not involve inverse quantization which is followed by re-quantization. Therefore, there is an advantage that re-quantization errors are not accumulated.

In the fourth exemplary embodiment, the number of additional bits is fixedly limited to 2 bits. However, the limit value of the number of additional bits may be appropriately changed in accordance with a group number (SSSS).

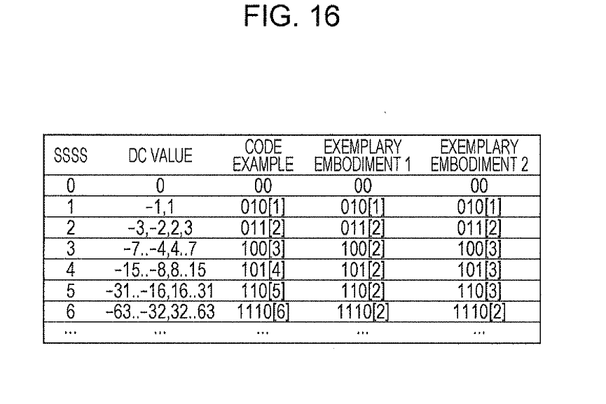

FIG. 16 illustrates an example of the case where the number of additional bits is changed in accordance with the group number (SSSS). In FIG. 16, “exemplary embodiment 1” is the case where the number of additional bits is limited to “2”, as above. In “exemplary embodiment 2”, the number of additional bits is set to “2” or “3” in accordance with the group number (SSSS). Specifically, the number of additional bits is limited to “3” when SSSS is 3 to 5, and the number of additional bits is limited to “2” when SSSS is 6 or other numbers. Needless to say, this is only an example, and the number of additional bits may be set to an arbitrary number under the idea that the number of additional bits is limited to a number less than the default number of additional bits.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image encoding apparatus comprising:
an input unit that receives, as an input, image data;
a prediction unit that calculates a predicted pixel value of a pixel of interest serving as a target to be processed in the image data;
a prediction error calculating unit that calculates a prediction error value by using an actual pixel value and the predicted pixel value of the pixel of interest; and
an encoder that encodes the prediction error value with information including a number of bits and an error value, the encoder encoding, as the error value, only one or more most significant bits corresponding to a number of effective bits when the number of bits exceeds the number of effective bits.

2. The image encoding apparatus according to claim 1, further comprising:
a quantization unit that quantizes the prediction error value encoded by the encoder; and
a feedback unit that sends, as a feedback, the quantized prediction error value to the prediction unit,
wherein the prediction unit calculates a prediction error value of a next pixel of interest by using the quantized prediction error value.

3. The image encoding apparatus according to claim 1, wherein the encoder uses, as the number of bits, a maximum value among numbers of bits representing prediction errors of a plurality of pixels included in a block of an image.

4. The image encoding apparatus according to claim 2, wherein the encoder uses, as the number of bits, a maximum value among numbers of bits representing prediction errors of a plurality of pixels included in a block of an image.

5. The image encoding apparatus according to claim 1, wherein the number of effective bits is a preset fixed number of bits.

6. The image encoding apparatus according to claim 1, wherein the number of effective bits is changeably set in accordance with the prediction error value sequentially calculated for the pixel of interest by the prediction unit.

7. An image decoding apparatus comprising:
an input unit that receives, as an input, encoded image data;
a cut-out unit that cuts out number-of-bit data and error data included in the encoded image data;
a prediction error value decoder that decodes the number-of-bit data, decodes the error data by using the number-of-bit data, and calculates a prediction error value; and
a pixel value calculating unit that calculates a pixel value of a pixel of interest by using the prediction error value.

8. A non-transitory computer readable medium storing a program causing a computer to execute a process, the process comprising:
receiving, as an input, image data;
calculating a predicted pixel value of a pixel of interest serving as a target to be processed in the image data;
calculating a prediction error value by using an actual pixel value and the predicted pixel value of the pixel of interest; and
encoding the prediction error value with information including a number of bits and an error value, and encoding, as the error value, only one or more most significant bits corresponding to a number of effective bits when the number of bits exceeds the number of effective bits.

9. An image encoding apparatus comprising:
an input unit that receives, as an input, image data;
a discrete cosine transform unit that performs discrete cosine transform of the image data; and
an encoder that performs Huffman coding of coefficients of the discrete-cosine-transformed image data, the encoder encoding only one or more most significant bits corresponding to a number of effective bits when a number of additional bits of the Huffman coding exceeds the number of effective bits.

10. An image encoding method comprising:
receiving, as an input, image data;
calculating a predicted pixel value of a pixel of interest serving as a target to be processed in the image data;
calculating a prediction error value by using an actual pixel value and the predicted pixel value of the pixel of interest; and
encoding the prediction error value with information including a number of bits and an error value, and encoding, as the error value, only one or more most significant bits corresponding to a number of effective bits when the number of bits exceeds the number of effective bits.

11. An image decoding method comprising:
receiving, as an input, encoded image data;
cutting out number-of-bit data and error data included in the encoded image data;
decoding the number-of-bit data, decoding the error data by using the number-of-bit data, and calculating a prediction error value; and
calculating a pixel value of a pixel of interest by using the prediction error value.
